(19) United States
(12) Patent Application Publication
(10) Pub. No.: US 2010/0098264 A1
(43) Pub. Date: Apr. 22, 2010

(54) SPORTS COMMUNICATION SYSTEM

(76) Inventor: Adam Patrick Gutierrez, Broomfield, CO (US)

Correspondence Address: MICHAEL RIES, 318 PARKER PLACE, OSWEGO, IL, 60543, US

(21) Appl. No.: 12/582,526

(22) Filed: Oct. 20, 2009

Related U.S. Application Data
(60) Provisional application No. 61/107,244, filed on Oct. 21, 2008.

(51) Int. Cl. H04B 3/00

(52) U.S. Cl. 381/77; 455/66.1

(57) ABSTRACT

A communication device is disclosed comprising: an RF receiver circuit for receiving wireless signals from a designated transmitting device; a receiver audio circuit for converting the received wireless signals into audio waveforms; a speaker for converting the audio waveforms into sound information; and a receiver housing for enclosing the speaker, the receiver housing including a speaker mesa protruding from the receiver housing, the speaker mesa configured to fit into the ear of a user.

### CROSS REFERENCE TO RELATED APPLICATION

The present Application claims the benefit of Provisional Patent Application No. 61/107,244 entitled “Hed Gear,” filed 21 Oct. 2008 and incorporated by reference herein in its entirety.

### BACKGROUND OF THE INVENTION

1. Field of the Invention

The present invention relates generally to wireless communication devices and, in particular, to a communication system providing one-way communication to an athlete performing in a competitive sport.

2. Description of Related Art

Most conventional sports communication devices are configured for two-way communication and are provided as part of a sports helmet, which makes such devices relatively expensive and not suitable for application to some types of sports activities. For example, U.S. Pat. No. 6,009,563 issued to Swanson et al. discloses a sports safety helmet providing two-way radio communication where a radio transmitter and a battery are incorporated integrally into the helmet.

U.S. Pat. No. 6,732,381 issued to Lal discloses a sports helmet that may include an MP3 player, a radio, and a cellular telephone.

What is needed is a communication device which can be used in sports activities not requiring helmets, and which is less costly, allowing for use in amateur sports.

### SUMMARY OF THE INVENTION

In an exemplary embodiment of the present invention, there is disclosed a communication device comprising: an RF receiver circuit for receiving wireless signals from a designated transmitting device; a receiver audio circuit for converting the received wireless signals into audio waveforms; a speaker for converting the audio waveforms into sound information; and a receiver housing for enclosing the speaker, the receiver housing including a speaker mesa protruding from the receiver housing, the speaker mesa configured to fit into the ear of a user.

In another exemplary embodiment of the present invention, there is disclosed a communication system comprising: a transmitter having an RF transmission circuit and a transmitter audio circuit, the transmitter for providing spoken information via a wireless signal; and a receiver for converting the wireless signal into the spoken information, the receiver enclosed in a receiver housing having a protruding speaker mesa, the speaker mesa configured to fit into the ear of a user.

In still another exemplary embodiment of the present invention, there is disclosed a method of using a designated transmitter to send spoken information to an athlete performing in an athletic competition, the method comprising: providing a sports communication device to the athlete, the sports communication device configured to receive wireless communication from the designated transmitter, the sports communication device mounted to the head of the athlete such that a protruding speaker mesa on the sports communication device is positioned within the ear of the athlete; directing the spoken information into a microphone provided on the designated transmitter; converting the spoken information into a wireless signal; receiving the wireless signal at the sports communication device; converting the received wireless signal into an audio message such that the audio message is substantially confined to the auditory canal of the athlete, the audio message corresponding to the spoken information sent from the designated transmitter.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that the disclosed conception and exemplary embodiments can be used as bases for designing or modifying other structures or methods for carrying out the same purposes of the present invention and that such other structures and methods do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a diagrammatical illustration of a sports communication system comprising a transmitter in one-way communication with a receiver, in accordance with the principles of the invention;

FIG. 2 is a diagrammatical side and front view of an exemplary embodiment of a receiver as may be used in the sports communication system of FIG. 1;

FIG. 3 is a pictorial representation of an exemplary embodiment of an exemplary embodiment of a transmitter as may be used in the sports communication system of FIG. 1; and

FIG. 4 is an illustration of a sports communication system, in accordance with the principles of the invention, shown in use by a wrestling coach to communicate with a team member participating in a wrestling match.

### DESCRIPTION OF THE PREFERRED EMBODIMENT

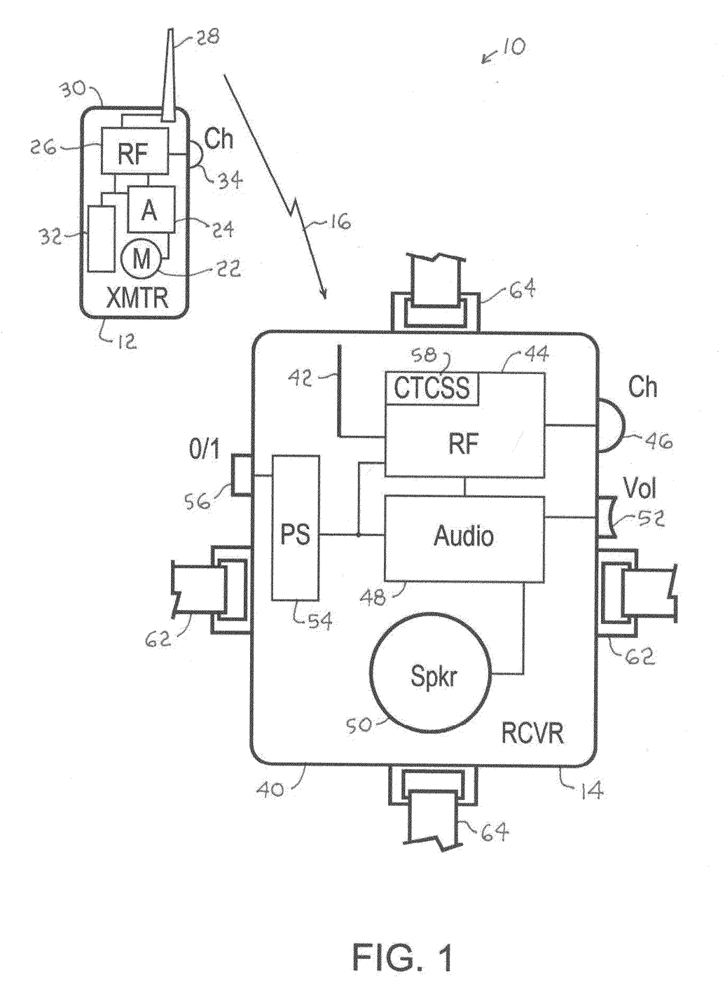

Referring to FIG. 1, there is shown a simplified diagrammatical illustration of an exemplary embodiment of a communication system 10 comprising a transmitter 12 configured to emit a wireless signal 16 to a receiver 14, in accordance with the present invention. As described in greater detail below, the transmitter 12 may be used by a sports coach (not shown) to send audio information to an athlete during a competition, or to any sports participant (not shown), wearing the receiver 14.

The transmitter 12 may include a microphone 22 for inputting a spoken message, or other audio signals, to a transmitter audio circuit 24. The transmitter audio circuit 24 functions to convert the audio signals from the microphone 22 to an electronic signal suitable for transmission by an RF transmission circuit 26, as well known in the art. The wireless signal 16 may be emitted by a transmitter antenna 28 attached to a transmitter housing 30 enclosing components of the transmitter 12. A power source 32 may provide electrical power to the transmitter audio circuit 24 and the RF transmission circuit 26.

The sports coach, or other user, may select one of a plurality of available communication channels by means of a transmitter channel selector 34 mounted to the transmitter housing 30 before directing a spoken message or spoken information into the microphone 22. In an exemplary embodiment, the transmitter 12 may function using twenty channels, assigned to frequencies ranging from 462.5625 to 462.7250 MHz operating in accordance with the IEEE standard 802 (“Bluetooth”). The transmitter 12 may thus operate at a frequency of about 2.4 GHz, may have an effective range of at least ten meters, and may have a data transfer rate of at least one Mbps.

The wireless signal 16 may be acquired by a receiver antenna 42 retained inside a receiver housing 40. A receiver channel selector 46 attached to the receiver housing 40 may be used to set the receiver 14 to the same communication channel as the transmitter 12. In an exemplary embodiment, the receiver 14 may have a receiver sensitivity of about −120 dBm and an adjacent channel rejection of about 60 dB. The wireless signal 16 may be converted into audio signals, corresponding to the spoken message or spoken information, by means of an RF receiver circuit 44. In an exemplary embodiment, the incoming wireless signal 16 may be passed to a continuous tone-coded squelch system (CTCSS) 58 in the RF receiver circuit 44 to filter out unwanted communication signals before conversion to the audio signals. A receiver audio circuit 48 provides amplified, converted audio signals to a speaker 50 which is preferably placed at the ear of the sports participant, as described in greater detail below. A volume control 52 attached to the receiver housing 40 may provide for adjustment of the audio volume from the speaker 50. A power source 54, controlled by an on/off switch 56, may be used to provide electrical power to the

RF receiver circuit 44 and to the receiver audio circuit 48. The power source 54 and the power source 32 may each operate at a nominal level of about 3.7 Vdc.

In an alternative exemplary embodiment, an optional first flexible strap 62, attached to the receiver housing 40, may be provided for positioning and securing the receiver 14 to the head of the sports participant. The first flexible strap 62 functions to prevent movement of the receiver 14 along a first direction with respect to the head of the sports participant. Additionally, an optional second flexible strap 64 may be provided for further attaching the receiver 14 to the head of the sports participant. The second flexible strap 64 functions to prevent movement of the receiver 14 along a second direction with respect to the head of the sports participant. In an exemplary embodiment, the first flexible strap 62 may be positioned against the forehead of the sports participant, and the second flexible strap 64 may pass under the chin of the sports participant.

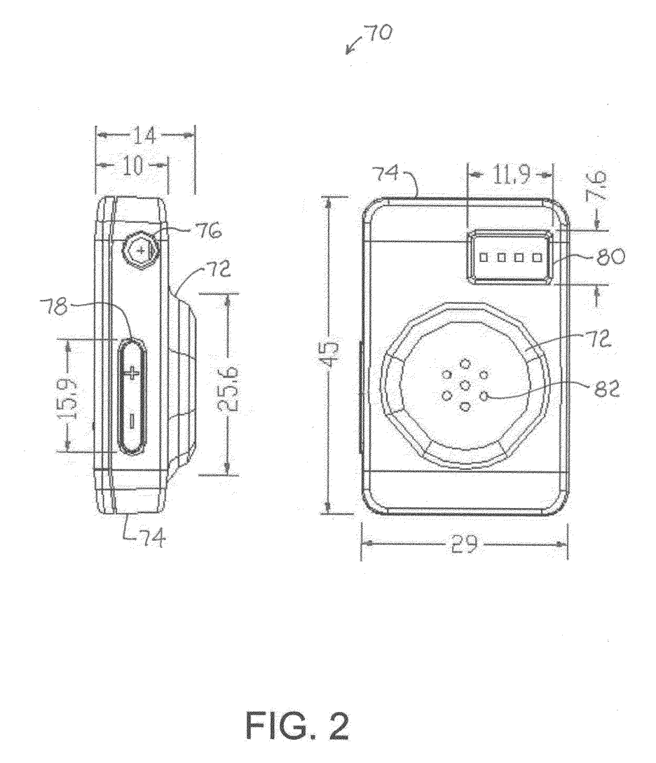

Referring to FIG. 2, there is shown front and side views of an exemplary embodiment of a sports communication device 70 that can be used for a receiver in the communication system 10 of FIG. 1. The interior components (not shown) of the sports communication device 70 are substantially similar to those components shown in FIG. 1 as comprising the receiver 14. The sports communication device 70 has external dimensions of approximately 29 mm×45 mm×14 mm, allowing for unobtrusive placement of the sports communication device 70 inside a batter's helmet, a football helmet, a lacrosse helmet, a hockey helmet, or inside a wrestler's head gear, for example. If required, the sports communication device 70 may include either or both of the first flexible strap 62 and the second flexible strap 64 if the sports participant is competing in an activity not requiring a helmet such as, for example, tennis or track events.

The sports communication device 70 preferably includes a protruding speaker mesa 72 formed as part of the device housing 74, where the speaker 50 (shown in FIG. 1) is emplaced substantially inside the speaker mesa 72. In an exemplary embodiment, the speaker mesa 72 may have a diameter of approximately 25 mm and may protrude about 4 mm from the approximately 10 mm thick main portion of the device housing 74. The speaker mesa 72 is configured to fit inside the outer ear of a player, such that, when in use, the speaker mesa 72 can be positioned within the ear to thus efficiently direct sound substantially into the player's auditory canal. This configuration thus serves to isolate the sound generated by the speaker from the ambient noise surrounding the player, which minimizes erroneous communication from a coach to the player, for example, and further allows the coach to provide instructions without the need to use hand signals that may convey information to an opposing team or opponent.

The sports communication device 70 comprises a volume/channel control 78 having dimensions of approximately 16 mm×3 mm, for setting volume level and/or selecting a communications channel, and may further include a charging port 76 for connecting to an external power supply. In an alternative exemplary embodiment, the charging port 76 may have a configuration suitable for interfacing via a Universal Serial Bus (USB) connector (not shown). There may be provided a visual display 80, such as a liquid crystal display (LCD) for example, approximately 12 mm×7.6 mm in size showing: volume level, communications channel selected, status of battery, and other information of interest to the user. The device housing 74 may be fabricated from an impact resistant material such as plastic, as is well known in the art. A plurality of speaker openings 82 may be provided to improve the clarity of the spoken message or spoken information emanating from the internal speaker 50 (not shown).

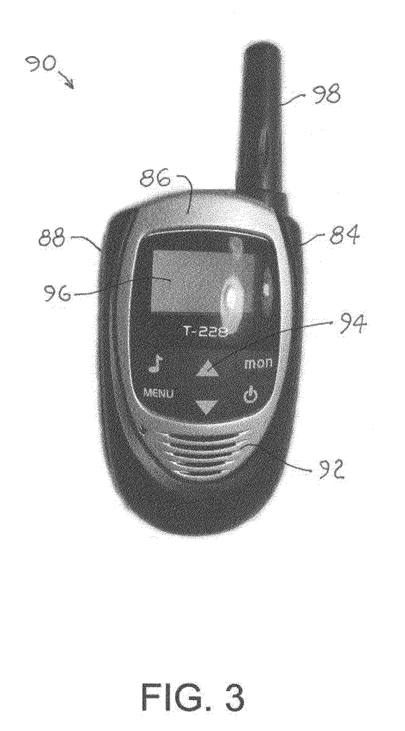

Referring to FIG. 3, there is a pictorial representation of an exemplary embodiment of a sports communication transmitter 90 as may be used for a transmitter in the communication system 10 of FIG. 1. In an exemplary embodiment, the sports communication transmitter 90 comprises a transmitter housing 84 shaped and sized to fit into a user's hand such that the user can: turn on the unit by using a power button 88; easily speak into a microphone 92; make channel selections via a channel selector control 94; and view a visual display 96 to determine transmitter settings. An external transmitter antenna 98 may be provided to enhance radio transmission.

In an exemplary embodiment, a user may operate the sports communication transmitter 90 by holding down the power button 88 for a predetermined length of time, such as for three seconds. This action may bring up the visual display 96 on a front face 86. A channel selection may be made using the channel selector control 94. Once the channel selection is confirmed, a CTCSS code may appear in the visual display 96. The user can select whether the CTCSS code is correct, or may select and store another code ranging from a “00” code (non-scripted, 0.0 Hz), for example, to higher, scripted codes denoted as CH1 (67.0 Hz) to CH38 (250.3 Hz). The volume level of the sports communication transmitter 90 may also be adjusted as required.

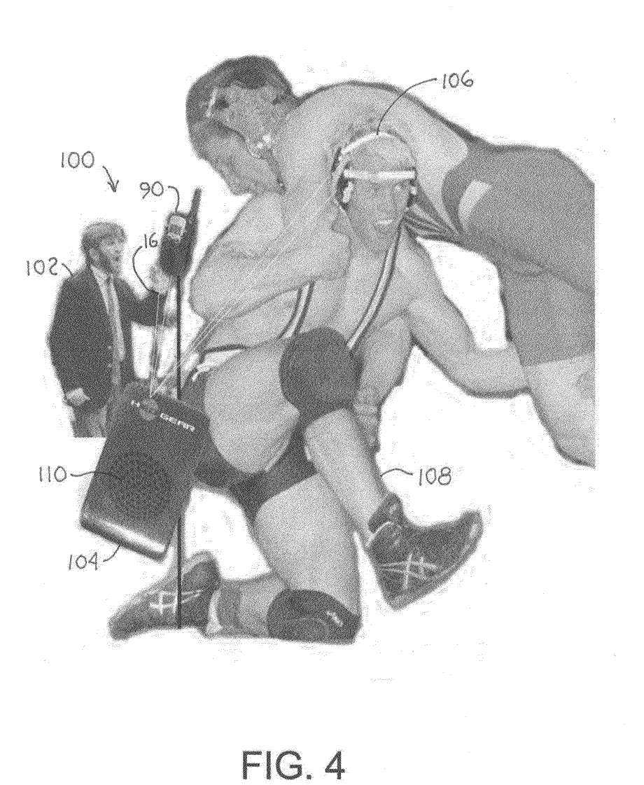

Referring to FIG. 4, there is a pictorial representation of an exemplary embodiment of a sports communication system 100 comprising the sports communication transmitter 90 of FIG. 3 and a sports communication device 104, having all the features and functions found in the sports communication device 70 of FIG. 2. A coach 102 is shown using the sports communication transmitter 90, by speaking or directing his information into the microphone 92, to send instructions to the sports communication device 104 via the wireless signal 16. The intended recipient of the instructions is an athlete in competition, here exemplified by a wrestler 108 who has the sports communication device 104 secured under his head gear 106 such that a speaker 110 is emplaced in the ear of the wrestler 108.

The sports communication device 104 functions to convert the wireless signal 16 into an audio signal corresponding to the instructions spoken by the coach 102. The speaker 110, in turn, functions to convert the received audio signal into sound that is substantially the same spoken information provided to the sports communication transmitter 90 by the coach 102. Because the speaker 110 is configured, by means of the protruding speaker mesa 72 (shown in FIG. 2) to fit into the ear of the wrestler 108, the instructions spoken by the coach 108 are substantially confined to the auditory canal of the wrestler 108. In effect, the sports communication system 100 conveys the spoken information or spoken message from the coach 102 directly to the wrestler 108, but to no one else.

As disclosed above, the correct or desired play can be communicated to the wrestler 108 without risking the use of hand signals by the coach 102, an action which might otherwise reveal the next move to the opposing coach (not shown). It can be appreciated by one skilled in the art that the sports communication system 100 is highly portable, provides basic functions, and can easily be adapted to amateur sports activities.

While there have been shown and described and pointed out the fundamental novel features of the invention as applied to the exemplary embodiments, it will be understood that various omissions and substitutions and changes of the form and details of the apparatus illustrated and in the operation may be done by those skilled in the art, without departing from the spirit of the invention.

What is claimed is:

1. A communication device suitable for use with a designated transmitting device, said communication device comprising:
an RF receiver circuit for receiving wireless signals from the designated transmitting device;
a receiver audio circuit for converting said received wireless signals into audio waveforms;
a speaker for converting said audio waveforms into sound information; and
a receiver housing for enclosing said speaker, said receiver housing including a speaker mesa protruding from said receiver housing, said speaker mesa configured to fit into the ear of a user.

2. The communication device of claim 1 wherein said communication device is configured to fit unobtrusively between a helmet worn by the user and the user's head.

3. The communication device of claim 1 wherein the designated transmitting device and said communication device operate at a frequency of approximately 2.4 GHz.

4. The communication device of claim 1 wherein the designated transmitting device and said communication device communicate at distances of at least thirty feet.

5. The communication device of claim 1 wherein the designated transmitting device and said communication device communicate at data rates of at least one Mbps.

6. The communication device of claim 1 further comprising attachment means for positioning and securing said housing to said user's head such that sound from said speaker is directed substantially into the auditory canal of said user.

7. The communication device of claim 6 wherein said attachment means is configured to prevent motion of said housing relative to said user's head along the direction of said attachment means.

8. The communication device of claim 6 wherein said attachment means comprises one of a chin strap and a head band.

9. A communication system comprising:
a transmitter having an RF transmission circuit and a transmitter audio circuit, said transmitter for providing spoken information via a wireless signal; and
a receiver for converting said wireless signal into said spoken information, said receiver enclosed in a receiver housing having a protruding speaker mesa, said speaker mesa configured to fit into the ear of a user.

10. The communication system of claim 9 wherein said receiver comprises:
an RF receiver circuit for receiving said wireless signal;
a receiver audio circuit for converting said wireless signal to audio waveforms; and
a speaker for converting said audio waveforms into the spoken information.

11. The communication system of claim 10 wherein said speaker is emplaced substantially within said speaker mesa.

12. The communication system of claim 9 wherein said receiver is configured to fit between the head of a user and a sports helmet worn by said user.

13. The communication system of claim 9 wherein said transmitter and said receiver operate in conformance with IEEE standard 802.

14. A method of using a designated transmitter to send spoken information to an athlete performing in an athletic competition, said method comprising the steps of:
providing a sports communication device to the athlete, said sports communication device configured to receive wireless communication from the designated transmitter, said sports communication device mounted to the head of the athlete such that a protruding speaker mesa on said sports communication device is positioned within the ear of the athlete;
directing the spoken information into a microphone provided on the designated transmitter;
converting the spoken information into a wireless signal;
receiving said wireless signal at said sports communication device; and
converting said received wireless signal into an audio message such that said audio message is substantially confined to the auditory canal of the athlete, said audio message corresponding to the spoken information sent from the designated transmitter;

15. The method of claim 14 further comprising the step of setting said sports communication device to the same communications channel as the designated transmitter.

16. The method of claim 14 wherein said wireless signal conforms to IEEE standard 802.

17. The method of claim 14 wherein said wireless signal is passed to a continuous tone-coded squelch system in said sports communication device.
